(19) United States
(12) Patent Application Publication
(10) Pub. No.: US 2013/0092703 A1
(43) Pub. Date: Apr. 18, 2013

(54) Collapsible Containers, Collapsible Container Dispensers, and Methods of Dispensing a Collapsible Container

(71) Applicant: ICE HOUSE AMERICA, LLC, Jacksonville Beach, FL (US)

(72) Inventors: Ernest Chip Venet, III, Jacksonville Beach, FL (US); Daniel LaDon Dunn, Jacksonville Beach, FL (US)

(73) Assignee: ICE HOUSE AMERICA, LLC, Jacksonville Beach, FL (US)

(21) Appl. No.: 13/653,890

(22) Filed: Oct. 17, 2012

Related U.S. Application Data
(60) Provisional application No. 61/547,847, filed on Oct. 17, 2011.

(51) Int. Cl. G07F 11/16

(52) U.S. Cl. 221/232

(57) ABSTRACT

A collapsible container dispenser dispenses a collapsible container. In a collapsed state, the collapsible container has a thickness that is much smaller than its length and width. In some embodiments, the collapsible container is an insulated cooler designed for containing ice. The collapsible containers are preferably stacked at an angle in the dispenser prior to being dispensed. In some embodiments, the only moving mechanical part in the dispenser is a push bar, which pushes a collapsible container toward an opening in the dispenser to dispense the collapsible container. In some embodiments, at least one wing maintains the collapsible container to be dispensed on the floor of the holding area as the push bar extends to push the collapsible container through the dispensing opening. In some embodiments, the dispenser also dispenses ice that may be contained in the collapsible container.

### REFERENCE TO RELATED APPLICATIONS

This application claims one or more inventions which were disclosed in Provisional Application No. 61/547,847, filed Oct. 17, 2011, entitled “COLLAPSIBLE CONTAINERS, COLLAPSIBLE CONTAINER DISPENSERS, AND METHODS OF DISPENSING A COLLAPSIBLE CONTAINER”. The benefit under 35 USC §119(e) of the United States provisional application is hereby claimed, and the aforementioned application is hereby incorporated herein by reference.

This application is related to co-pending U.S. application Ser. No. 12/871,632, filed Aug. 30, 2010, entitled “AUTOMATED ICE BAGGING APPARATUS AND METHODS”, which is a continuation of U.S. application Ser. No. 12/106,072, filed Apr. 18, 2008, now U.S. Pat. No. 7,806,152, which is a continuation of U.S. application Ser. No. 11/397,687, filed Apr. 5, 2006, now U.S. Pat. No. 7,426,945, which is a continuation of U.S. application Ser. No. 11/110,924, filed Apr. 21, 2005, now U.S. Pat. No. 7,104,291, which is a continuation of U.S. application Ser. No. 10/715,563, filed Nov. 19, 2003, now U.S. Pat. No. 6,932,124. The aforementioned applications are hereby incorporated herein by reference.

### BACKGROUND OF THE INVENTION

1. Field Of The Invention

The invention pertains to the field of containers. More particularly, the invention pertains to collapsible containers, and dispensers and methods of dispensing for collapsible containers.

2. Description Of Related Art

U.S. Pat. No. 7,735,527, entitled “AUTOMATED ICE DELIVERY APPARATUS AND METHOD” and issued Jun. 15, 2010 to Dunn, discloses an ice vending apparatus that includes a holding vessel, an ice metering device, an ice transferring device, and a device for facilitating the movement of ice through the aperture, such as an ice circulation device or moisture inhibiting device. The ice circulation device inhibits or prevents the freezing together and buildup of ice pieces within the apparatus, while the moisture inhibiting device inhibits or prevents the undesirable transfer of moisture to different parts of the apparatus. Methods of delivering ice to a consumer are also disclosed.

U.S. Pat. No. 7,900,660, entitled “AUTOMATED ICE VENDING APPARATUS AND METHODS OF USE THEREOF” and issued Mar. 8, 2011 to Ladson, discloses an automated ice vending apparatus and method including an ice generating machine capable of producing enough ice to sufficiently keep full a first receptacle positioned beneath the ice generating machine. Augers, positioned at least partially within channels on the lower portion of the receptacle, move ice from the first receptacle to a second receptacle with a second ice moving mechanism, which in turn moves the ice to a third, substantially inclined, ice moving mechanism. The subsequent transfer of ice to a removable container is also disclosed.

U.S. Pat. No. 7,958,918, entitled “AUTOMATED ICE VENDING APPARATUS AND METHOD” and issued Jun. 14, 2011 to Ladson, discloses an automated ice vending apparatus and method including an ice-generating machine capable of producing enough ice to sufficiently keep full a receptacle positioned beneath the ice generating machine. Ladson also discloses a first ice moving device with cutting members positioned within the receptacle to move ice from the receptacle to a second ice moving device. The subsequent transfer of ice to a removable container is also disclosed.

The above-mentioned patents are hereby incorporated by reference herein.

### SUMMARY OF THE INVENTION

A collapsible container dispenser dispenses a collapsible container. In a collapsed state, the collapsible container has a thickness that is much smaller than its length and width. In some embodiments, the collapsible container is an insulated cooler designed for containing ice. The collapsible containers are preferably stacked at an angle in the dispenser prior to being dispensed. In some embodiments, the only moving mechanical part in the dispenser is a push bar, which pushes a collapsible container toward an opening in the dispenser to dispense the collapsible container. In some embodiments, at least one wing maintains the collapsible container to be dispensed on the floor of the holding area as the push bar extends to push the collapsible container through the dispensing opening. In some embodiments, the dispenser also dispenses ice that may be contained in the collapsible container.

### BRIEF DESCRIPTION OF THE DRAWINGS

FIG. 1 shows a schematic side view of a dispenser in position to dispense a smaller collapsible container in an embodiment of the present invention.

FIG. 2 shows a schematic side view of the dispenser of FIG. 1 with the collapsible container in a dispensed position.

FIG. 3 shows a schematic top view of the dispenser of FIG. 1 in the position of FIG. 1.

FIG. 4 shows a schematic top view of the dispenser of FIG. 1 in the position of FIG. 2.

FIG. 5 shows a schematic perspective view of a dispenser to dispense a larger collapsible container in an embodiment of the present invention.

FIG. 6 shows a partial cross sectional top view of the dispenser of FIG. 5.

FIG. 7 shows a partial cross sectional side view of the dispenser of FIG. 5 with no collapsible containers.

FIG. 8 shows a partial cross sectional side view of the dispenser of FIG. 5 with collapsible containers.

FIG. 9 shows the dispenser of FIG. 8 in a first position of a dispensing cycle.

FIG. 10 shows the dispenser of FIG. 8 in a second position of a dispensing cycle.

FIG. 11 shows the dispenser of FIG. 8 in a third position of a dispensing cycle.

FIG. 12 shows a partial cross sectional top view of a dispenser with wings ready to dispense a collapsible container in an embodiment of the present invention.

FIG. 13 shows the dispenser of FIG. 12 with a dispensed collapsible container.

FIG. 14 shows a partial cross sectional back view of the dispenser of FIG. 12.

### DETAILED DESCRIPTION OF THE INVENTION

A collapsible container dispenser uses a push bar to push a collapsible container through an opening to dispense the collapsible container. The awaiting collapsible container bottom preferably rests on the top of the push bar, while the top of the collapsible container rests at an angle so that the customer can not reach in and access the collapsible containers waiting to be dispensed. In some embodiments, wings are mounted to hinges on the side of the collapsible container dispenser. The wings are preferably mounted such that once the push bar is retracted, the awaiting collapsible container falls past the wings, and the wings keep the collapsible container held down. This addresses the potential concern of the push bar pushing the collapsible container back up instead of pushing it out to the customer.

The term “containment state”, as used herein, refers to the state of a container in which the container is capable of serving the purpose of containing one or more items. In a preferred embodiment, the containment state is the state of the container which has a maximum contained volume for the container design.

The terms “collapsed” and “collapsed state”, as used herein, refer to the state of an empty container which has been reduced in size in at least one dimension from a containment state. In a preferred embodiment, the size of the container is minimized in at least one dimension in the collapsed state, thereby removing essentially all of the containment space of the container. In some embodiments, the collapsed state is maintained by packaging for the container. In other embodiments, the collapsed state is maintained without any packaging or external pressure on the container.

The term “collapsible container”, as used herein, refers to any container that can be reversibly converted between a collapsed state and a containment state.

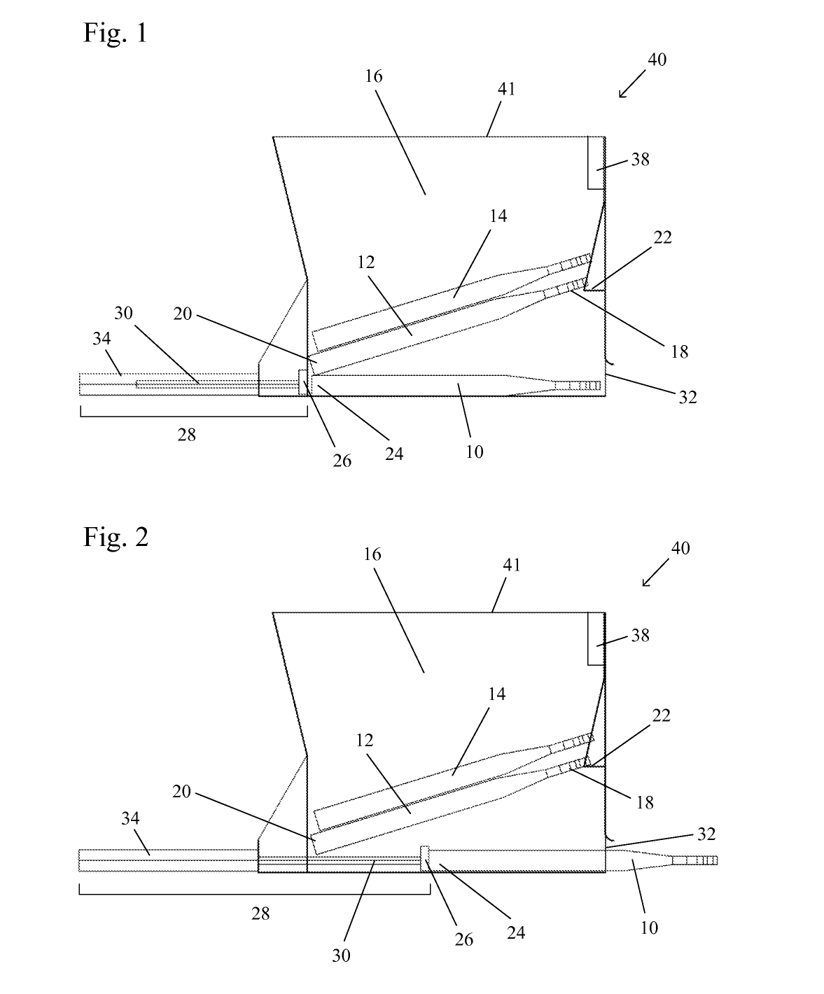

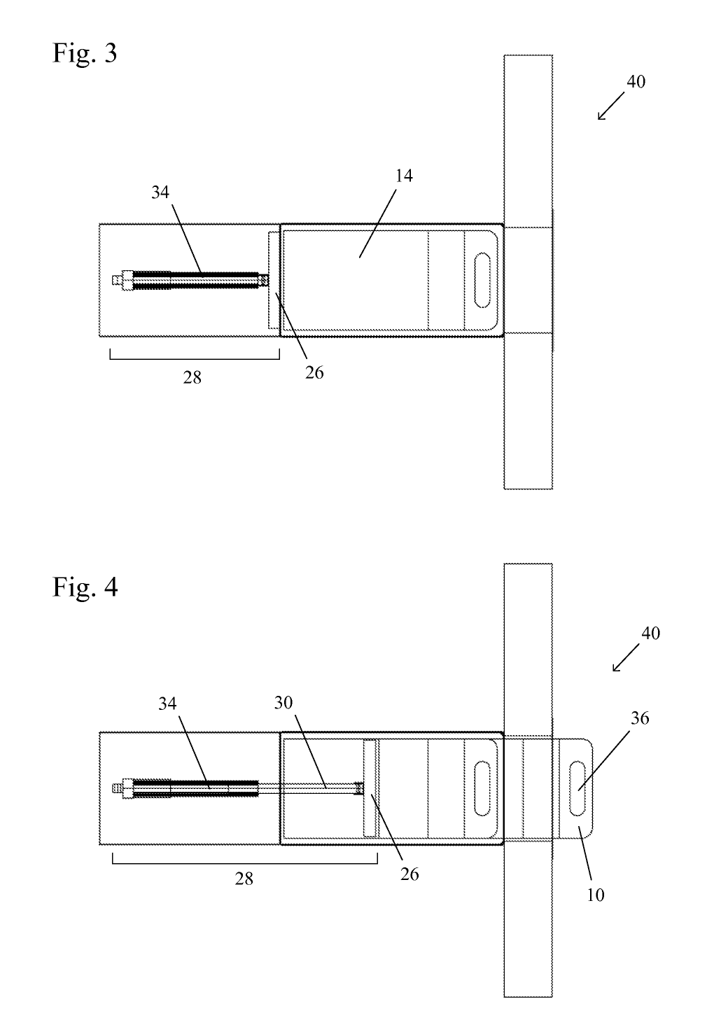

Referring to FIG. 1 through FIG. 4, collapsible containers 10, 12, 14 are stacked in a collapsed state at an angle in the holding area 16 of a collapsible container dispenser 40. The holding area 16 is formed within a dispenser housing 41. The front end 18 of the bottom angled collapsible container 12 of the stack is held at a predetermined height above the back end 20 of the container 12 by a projection 22 extending inwardly from the front wall of the holding area 16. Depending on the state of dispensing, the back end 20 of the container is held in position by contact with the back end 24 of the container 10 about to be dispensed, as in FIG. 1, or the front end 26 of a pushing mechanism 28 or the push bar 30 of the pushing mechanism 28, as shown in FIG. 2. The pushing mechanism 28 extends to the position shown in FIG. 2 to push a container 10 out a front opening 32 of the collapsible container dispenser 40. FIG. 3 and FIG. 4 show a push bar housing 34 from which the push bar 30 of the pushing mechanism 28 extends. The push bar housing 34 is preferably an air cylinder that actuates the push bar 30. FIG. 3 and FIG. 4 also show a handle 36 on the front end of the collapsible container 10 to aid the user in removing the dispensed container 10 from the collapsible container dispenser 40.

FIG. 1 through FIG. 4 show two positions of a collapsible container dispenser 40 in a method of dispensing collapsible containers. When the dispenser 40 is in a waiting state (not shown), the containers 12, 14 are preferably all stacked at an angle in the holding area 16 of the dispenser 40. In the waiting state, the pushing mechanism 28 is slightly extended from the position shown in FIG. 1 such that the back end 20 of the bottom angled container 12 rests on top of the pushing mechanism 28, thereby maintaining the front end 18 of the bottom angled container 12 of the stack on the projection 22.

When a dispensing cycle is initiated, the pushing mechanism 28 retracts to the position of FIG. 1, thereby allowing the front end 18 of the bottom angled container 12 to clear the projection 22 and fall to the horizontal position of the container 10 shown in FIG. 1. The container 14 above the bottom angled container 12, which is at this point horizontal, moves to the bottom angled position of the stack. The pushing mechanism 28 then extends to an extended position, such as the position shown in FIG. 2, to push the collapsible container 10 out an opening 32 of the collapsible container dispenser 40. The pushing mechanism 28 then retracts to the waiting state to complete the dispensing cycle. In an alternative embodiment of the method, the position shown in FIG. 2 serves as the waiting state for the method. In some embodiments, the method is initiated by the deposition of money into the collapsible container dispenser 40 by a user of the dispenser 40. A control mechanism 38 directs the pushing mechanism 28 during a dispensing cycle, and an air cylinder 34 actuates the push bar 30. In some embodiments, the control mechanism 38 is a control board, which may be located anywhere in or on the collapsible container dispenser 40 within the spirit of the present invention.

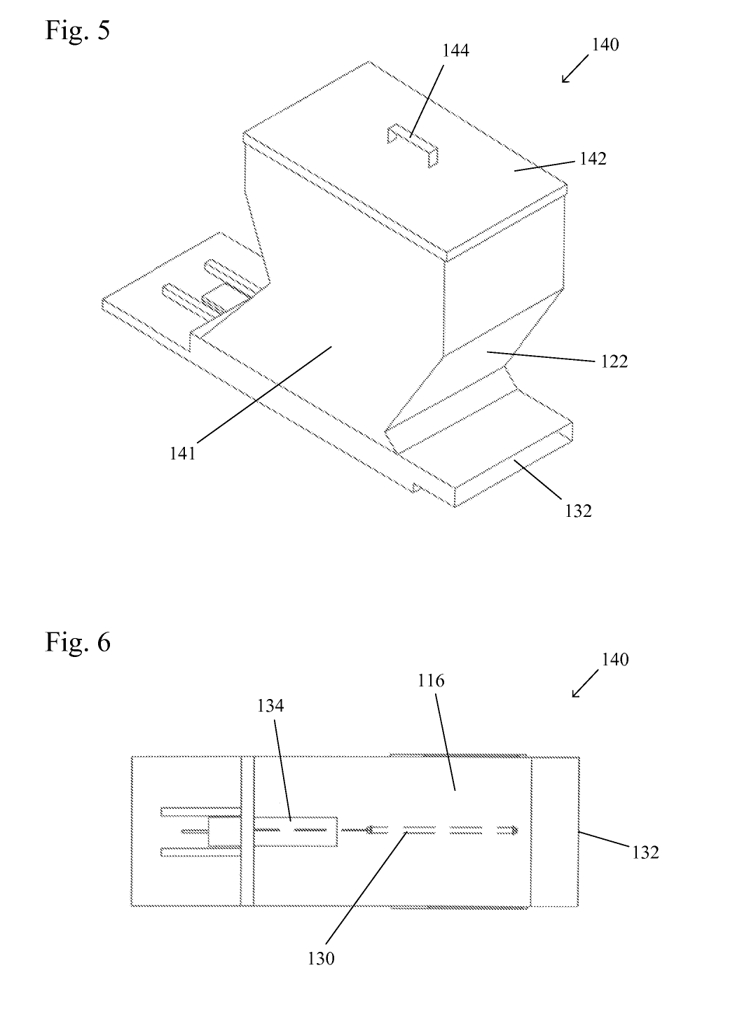

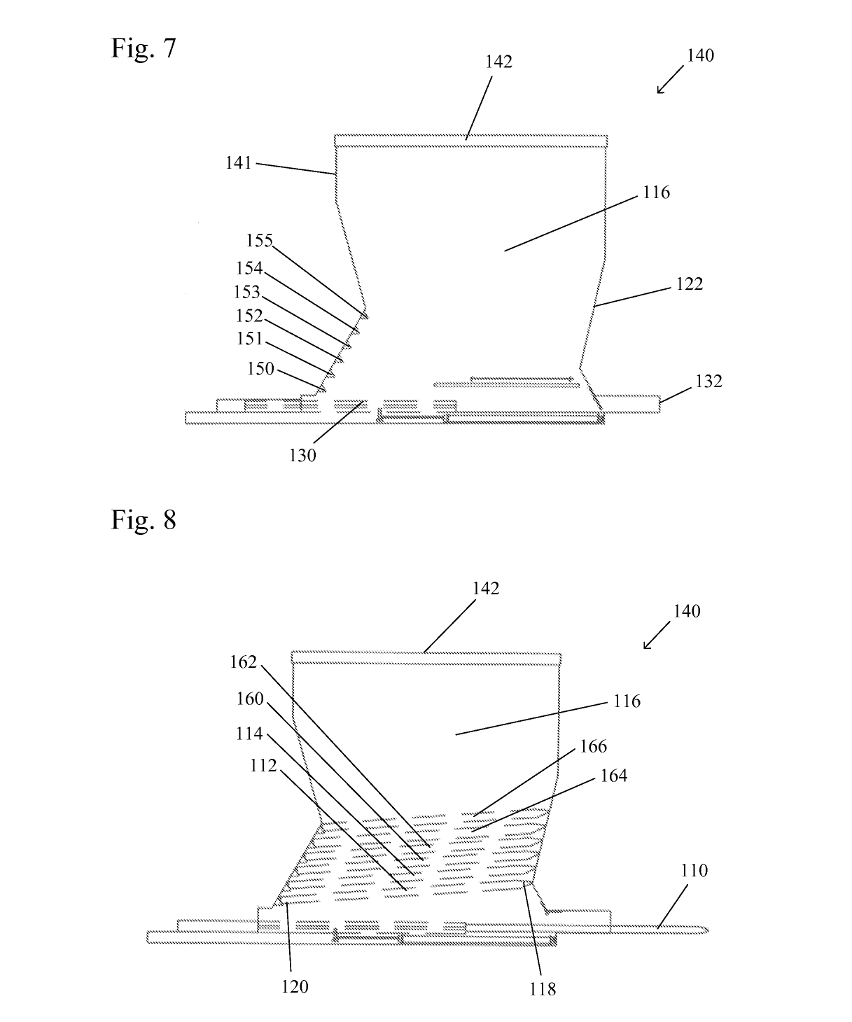

FIG. 5 through FIG. 7 show a preferred shape of a collapsible container dispenser 140. The holding area 116 is formed within a dispenser housing 141. The dispenser includes a lid 142 with a handle 144 on top of the holding area 116 for the collapsible containers. The lid 142 is preferably only removable by the vendor to provide access to the holding area 116 to add more collapsible containers to be dispensed or to otherwise access the holding area, such as to repair the collapsible container dispenser 140. A locking mechanism 180 maintains the lid 142 on the holding area to prevent customers from accessing the holding area. A push bar 130 extending from a push bar housing 134 actuates to dispense a collapsible container out the front opening 132 of the dispenser 140. The push bar housing 134 is preferably an air cylinder that actuates the push bar 130. The front wall projection 122 that supports the front ends of the collapsible containers and the front opening 132, though which the collapsible containers are dispensed, are visible in FIG. 5. The ridges 150, 151, 152, 153, 154, 155 that support the back ends of the collapsible containers are visible in FIG. 7.

Referring to FIG. 8, collapsible containers 112, 114, 160, 162, 164, 166 are stacked in a collapsed state at an angle in the holding area 116 of the collapsible container dispenser 140. The front end 118 of the bottom angled collapsible container 112 of the stack is held at a predetermined height above the back end 120 of the container 112 by a wall projection 122 extending down inwardly toward the holding area 116. The push bar 130 extends to the position shown in FIG. 8 to push a collapsible container 110 out the front opening 132 of the collapsible container dispenser 140.

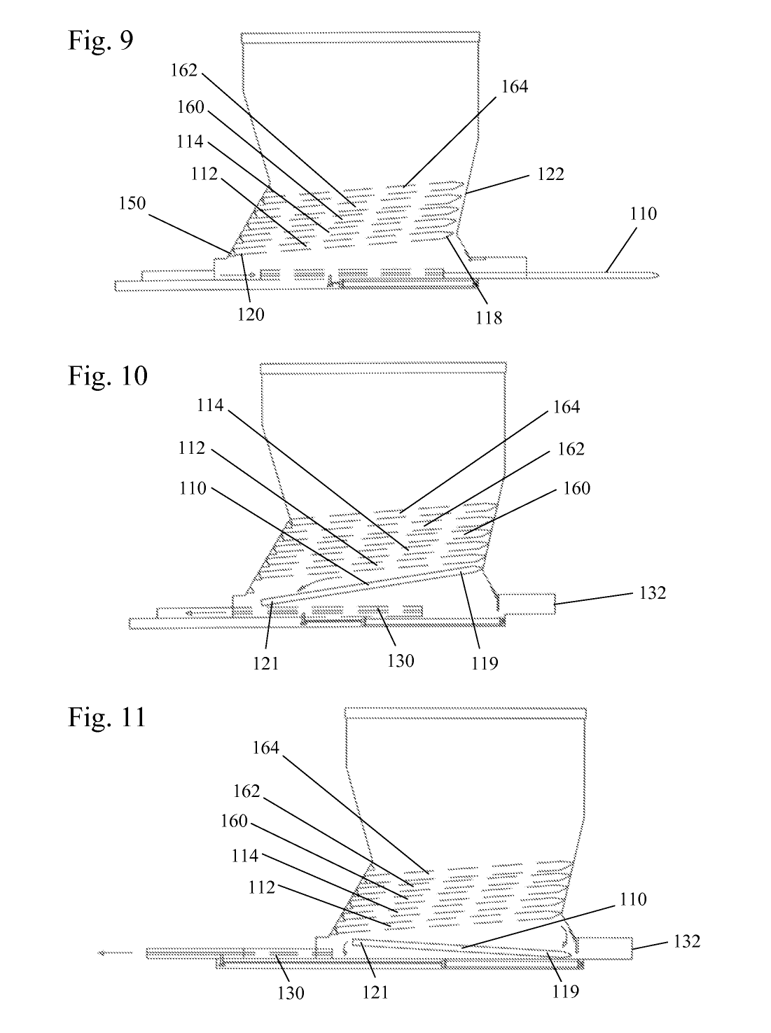

FIG. 9 through FIG. 11 show three positions of a collapsible container dispenser 140 in a method of dispensing collapsible containers 110, 112, 114, 160, 162, 164. When the dispenser is in a waiting state, such as in FIG. 9, once the user has removed the dispensed collapsible container 110, the remaining collapsible containers 112, 114, 160, 162, 164 are preferably all stacked at an angle in the holding area 116 of the dispenser. In the waiting state, the push bar 130 is extended as shown in FIG. 9. The back end 120 of the bottom angled container 112 is held up by the ridge 150 and the top of the push bar 130, thereby maintaining the front end 118 of the bottom angled container 112 of the stack on the projection 122. When a dispensing cycle is initiated, the push bar 130 retracts as shown in FIG. 10. This allows the back end 121 of the bottom container 110 to drop down from the ridge 150, thereby allowing the front end 119 of the bottom container 110 to clear the wall projection 122. The front end 119 falls to the bottom of the holding area 116 and once the push bar 130 fully retracts, the back end 121 also falls to the bottom of the holding area 116, as shown in FIG. 11, to a horizontal position. The collapsible container 112 above the bottom collapsible container 110, which is at this point horizontal, moves to the bottom angled position of the stack and bottom ridge 150, and each collapsible container 114, 160, 162, 164 above it moves down one position to the next-available ridge 151, 152, 153, 154, respectively. The push bar 130 then extends to an extended position, as shown in FIG. 9, to push the collapsible container 110 out the opening 132 of the collapsible container dispenser 140, thereby completing the dispensing cycle. In some embodiments, the method is initiated by the deposition of money into the collapsible container dispenser by a user of the dispenser.

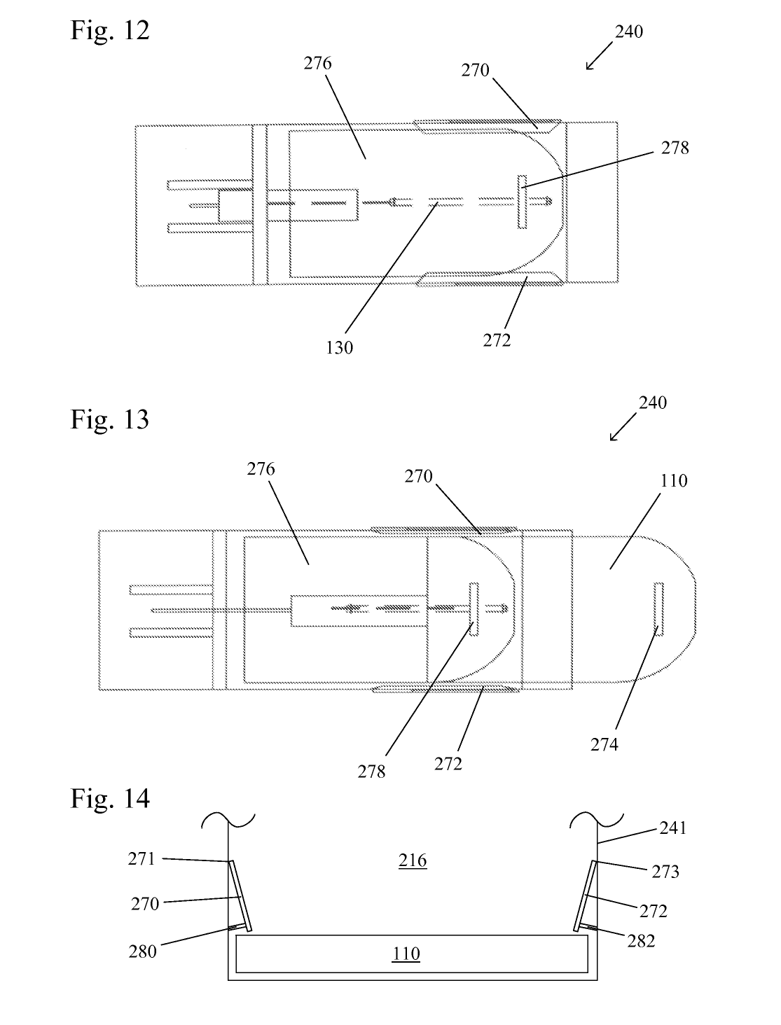

In FIG. 12, a pair of wings 270, 272 pivotably connected to the sides of the collapsible container dispenser 240 are shown in an extended position to maintain a collapsible container horizontally on the horizontal floor of the holding area as the push bar extends to dispense the collapsible container. In FIG. 13, the wings 270, 272 are shown in a retracted position as a collapsible container drops from the bottom angled position to the horizontal floor during the dispensing cycle. The wings 270, 272 are preferably mounted to the side walls of the dispenser housing 241 by hinges 271, 273 and are preferably spring-biased by springs 280, 282 toward the extended position, as shown in FIG. 14. When a collapsible container moves from the bottom angled position in the holding area 216 toward the horizontal vending position, the weight of the collapsible container is sufficient to rotate the wings 270, 272 against the spring bias to a retracted position. With the wings 270, 272 in the retracted position, the collapsible container is able to fall past the outer edges of the wings and lie flat on the bottom of the holding area. When the collapsible container lies flat on the bottom of the holding area, the springs bias the wings 270, 272 back to the extended positions, and the wings limit the upward movement of the horizontal collapsible container as the container is pushed out the front of the dispenser 240 by the push bar 130. Although the wings 270, 272 are only shown in FIG. 12 through FIG. 14, the wings 270, 272 may be used in any of the disclosed embodiments of the present invention. Although two wings are shown in FIG. 12 through FIG. 14, any number of wings may be used within the spirit of the present invention to perform the same function.

FIG. 12 and FIG. 13 also show handles 274, 278 on the front ends of the collapsible containers 110, 276 to aid the user in removing the dispensed collapsible container 110 from the collapsible container dispenser 240.

The stack of collapsible containers is preferably angled at a predetermined angle with respect to the line of action of the pushing mechanism. In some embodiments, the predetermined angle is selected to prevent theft of the collapsible containers from the collapsible container dispenser. In some embodiments, the predetermined angle is between about 20 and about 40 degrees. In some embodiments, the predetermined angle is about 30 degrees.

In some embodiments, the pushing mechanism is the only mechanical part for the method of dispensing. In some embodiments, the pushing mechanism is the only mechanical part of the dispenser. In some embodiments, the pushing mechanism is pneumatically actuated. In other embodiments, the pushing mechanism is mechanically actuated. In some embodiments, the pushing mechanism includes an air cylinder to push the collapsible container out. The stroke of the pushing mechanism is preferably between about 6 and 10 inches. In one embodiment, the stroke is about 8 inches.

In some embodiments, the collapsible container dispenser includes a sensor to sense when a collapsible container has been dispensed from the collapsible container dispenser.

The collapsible container is preferably re-useable. In some embodiments, the collapsible container is a cooler. In some embodiments, the collapsible container is insulated. In some embodiments, the collapsible container is designed to hold ice and is insulated to reduce melting of the ice during transportation of the ice in the collapsible container. In these embodiments, the collapsible container preferably includes a lid and the enclosed space is preferably sealable, such as by a zipper, clasp, or flap.

In some embodiments, the collapsible container is foldable.

In some embodiments, the collapsible container dispenser also dispenses an item which the collapsible container is designed to hold. In some embodiments, the collapsible container dispenser also dispenses ice. In some embodiments, the collapsible container is automatically dispensed with ice. In some embodiments, the collapsible container is automatically dispensed to a position for receiving and containing ice dispensed by the dispenser. In other embodiments, the collapsible container dispenser is located near or next to an ice dispenser. In some embodiments, the collapsible container dispenser is capable of accepting used collapsible containers for recycling or re-use. In some embodiments, the collapsible container dispenser requires payment by a user in order for a collapsible container or ice to be dispensed.

In some embodiments, at the rest position, the push bar is in the forward position with the back of the collapsible container resting on top of the push bar and the front of the collapsible container resting on the front wall of the storage compartment. This keeps someone from sticking something through the vending chute into the storage compartment and removing collapsible containers from the storage compartment.

In some embodiments, once a credit is received, the control board sends a signal to an air valve that closes an air cylinder. The air valve is preferably powered by compressed air. In some embodiments, the air cylinder is a 12-inch air cylinder. When the air cylinder closes, the air cylinder pulls the push bar to the back of the holding area allowing enough room so that the waiting collapsible container can drop down to the dispense position, then the control board activates the air cylinder to open, which pushes the push bar forward and the push bar pushes the collapsible container out the vending chute.

In some embodiments, the collapsible container is of the type marketed as Koolit Collapsible Coolers by Lifefoam Industries, LLC (Hunt Valley, Md., US).

In other embodiments, the collapsible container is of the type marketed as Pop-Up Coolers® containers by Wes-Pak, Inc. (Alexander, Ariz., US).

All above-mentioned references are hereby incorporated by reference herein.

Accordingly, it is to be understood that the embodiments of the invention herein described are merely illustrative of the application of the principles of the invention.

Reference herein to details of the illustrated embodiments is not intended to limit the scope of the claims, which themselves recite those features regarded as essential to the invention.

What is claimed is:

1. A collapsible container dispenser comprising:
a dispenser housing comprising a front wall, a back wall, and a pair of opposing side walls and forming a holding area within the dispenser housing, the dispenser housing having a dispensing opening in the front wall;
a dispensing mechanism comprising a push bar actuating between a retracted push bar position and an extended push bar position to dispense a collapsible container from the holding area through the dispensing opening; and
a control mechanism directing the dispensing mechanism;
wherein the collapsible container is maintained in an angled position in the holding area with a front end of the collapsible container being higher than a back end of the collapsible container by contact with a front wall extension, prior to the collapsible container being dispensed.

2. The collapsible container dispenser of claim 1, wherein a top surface of the push bar maintains the back end of the collapsible container, when the collapsible container is in the angled position.

3. The collapsible container dispenser of claim 1, wherein a ridge extending from the back wall of the dispenser housing maintains the back end of the collapsible container, when the collapsible container is in the angled position.

4. The collapsible container dispenser of claim 1, wherein the control mechanism comprises a control board.

5. The collapsible container dispenser of claim 1, wherein the dispensing mechanism further comprises an air cylinder actuating the push bar.

6. The collapsible container dispenser of claim 1 further comprising at least one wing pivotably connected to one of the pair of opposing side walls of the dispenser housing.

7. The collapsible container dispenser of claim 6, wherein:
the wing is actuatable between a retracted wing position and an extended wing position;
when the wing is in the extended wing position, the wing maintains the collapsible container on a floor of the dispenser housing as the push bar extends to dispense the collapsible container through the dispensing opening; and
when the wing is in the retracted wing position, the wing permits the collapsible container to drop from the angled position to the floor of the dispenser housing.

8. The collapsible container dispenser of claim 7, wherein the wing is biased toward the extended position by a spring.

9. The collapsible container dispenser of claim 1 further comprising a removable lid covering the holding area.

10. The collapsible container dispenser of claim 9 further comprising a locking mechanism controlling the removable lid on the holding area.

11. The collapsible container dispenser of claim 1, wherein the collapsible container is at an angle in a range of about 20 to about 40 degrees with respect to horizontal in the angled position.

12. A method of dispensing a collapsible container from a collapsible container dispenser, the method comprising the steps of:
a) maintaining the collapsible container in an angled position in a holding area of a dispenser housing of the collapsible container dispenser prior to dispensing the collapsible container;
b) releasing the collapsible container from the angled position such that the collapsible container falls to a floor of the dispenser housing; and
c) actuating a push bar between a retracted push bar position and an extended push bar position to dispense a collapsible container from the holding area through a dispensing opening in a front wall of the dispenser housing.

13. The method of claim 12, wherein step b) further comprises the sub-step of actuating the push bar between the extended push bar position and the retracted push bar position.

14. The method of claim 12, wherein a front end of the collapsible container is maintained higher than a back end of the collapsible container in the angled position by contact of the front end with an inward extension of a front wall of the dispenser housing.

15. The method of claim 12, wherein step c) comprises the sub-step of limiting an upward movement of the collapsible container as the push bar extends to dispense the collapsible container through the dispensing opening.

16. The method of claim 15, wherein at least one wing pivotably connected to a side wall of the dispenser housing in an extended position limits the upward movement of the collapsible container as the push bar extends to dispense the collapsible container through the dispensing opening; and
wherein:
when the wing is in the extended wing position, the wing maintains the collapsible container on a floor of the dispenser housing as the push bar extends to dispense the collapsible container through the dispensing opening; and
when the wing is in a retracted wing position, the wing permits the collapsible container to drop from the angled position to the floor of the dispenser housing.

17. The method of claim 12, wherein step c) further comprises the sub-step of directing an air cylinder to actuate the push bar.
